(19) United States
(12) Patent Application Publication
(10) Pub. No.: US 2025/0296349 A1
(43) Pub. Date: Sep. 25, 2025

(54) LIQUID DISCHARGE APPARATUS AND LIQUID DISCHARGE METHOD

(71) Applicant: Daiki ETO, Kanagawa (JP)

(72) Inventor: Daiki ETO, Kanagawa (JP)

(21) Appl. No.: 19/080,938

(22) Filed: Mar. 17, 2025

(30) Foreign Application Priority Data
Mar. 22, 2024 (JP) 2024-046924

(51) Int. Cl. B41J 2/21; B41J 2/005; B41J 2/01; B41J 3/407; B41J 11/00; B41M 5/00; B41M 5/025; D06P 5/24

(52) U.S. Cl. CPC B41J 2/2132; B41J 2/0057; B41J 2/2117; B41J 2/2121; B41J 11/0015; B41M 5/0017; B41M 5/0256; B41J 2002/012; B41J 3/4078; B41M 2205/06; B41M 2205/10; B41M 2205/42; D06P 5/003

(57) ABSTRACT

A liquid discharge apparatus includes a first head to discharge a color ink to a base material to transfer an image to a medium according to image data; a second head to discharge a white ink undercoating the color ink; a third head to discharge a treatment liquid containing an aggregating agent to the base material; and a control unit configured to: control the first head, the second head, and the third head to discharge the color ink, the white ink, and the treatment liquid, respectively; calculate a total adhesion amount of the color ink and the white ink discharged to each of regions of the image on the base material based on the image data; determine whether the total adhesion amount exceeds a predetermined threshold for each of the regions to determine a spot region; and control the third head to discharge the treatment liquid to the spot region.

### CROSS-REFERENCE TO RELATED APPLICATIONS

This patent application is based on and claims priority pursuant to 35 U.S.C. § 119(a) to Japanese Patent Application No. 2024-046924, filed on Mar. 22, 2024, in the Japan Patent Office, the entire disclosure of which is hereby incorporated by reference herein.

### BACKGROUND

### Technical Field

The present embodiment relates to a liquid discharge apparatus and a liquid discharge method.

### Related Art

As a liquid discharge apparatus, there is an inkjet recording apparatus using an inkjet technique. The liquid discharge apparatus includes a direct to film (DTF) printer.

In DTF printing, an ink is applied to a transferring base material such as a film, a thermally soluble adhesive powder is applied, and the adhesive powder is melted by heating. A printed material is superimposed on the film, and heated and pressurized to transfer an image to the printed material.

In the DTF printing, a technique has been proposed in order to prevent deterioration in quality of an image after transfer. In the DTF printing, a white ink might be used in addition to the clear ink, and the color ink and the white ink might be applied to a film to form an image for transfer. The white ink is used as an undercoat of the color ink in the printed material, and an image can be appropriately represented on the printed material even when the printed material has a dark color.

### SUMMARY

In an aspect of the present disclosure, a liquid discharge apparatus is provided that includes a first head to discharge a color ink to a base material to transfer an image to a medium according to image data; a second head to discharge a white ink undercoating the color ink; a third head to discharge a treatment liquid containing an aggregating agent to the base material; and a control unit configured to: control the first head, the second head, and the third head to discharge the color ink, the white ink, and the treatment liquid, respectively; calculate a total adhesion amount of the color ink and the white ink discharged to each of regions of the image on the base material based on the image data; determine whether the total adhesion amount exceeds a predetermined threshold for each of the regions to determine a spot region; and control the third head to discharge the treatment liquid to the spot region.

In another aspect of the present disclosure, a liquid discharge method is provided that includes: discharging a color ink to a base material to transfer an image to a medium according to image data; discharging a white ink undercoating the color ink; discharging a treatment liquid containing an aggregating agent to the base material; calculating a total adhesion amount of the color ink and the white ink discharged to each of regions of the image on the base material based on the image data; determining whether the total adhesion amount exceeds a predetermined threshold for each of the regions to determine a spot region; and discharging the treatment liquid to the spot region.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a liquid discharge apparatus according to an embodiment of the present embodiment in a state in which each cover member is closed;

FIG. 2 is a plan view of the liquid discharge apparatus of FIG. 1;

FIG. 3 is a perspective view of the liquid discharge apparatus in a state in which each cover member is opened;

FIG. 4 is a plan view of the liquid discharge apparatus of FIG. 3;

FIG. 5 is a flow of a comparative example;

FIGS. 6A to 6C are views for describing DTF printing of the comparative example;

FIGS. 7A and 7B are diagrams illustrating an example of a case where a color ink and a white ink are mixed;

FIG. 8 is a flow according to an embodiment of the present embodiment;

FIGS. 9A to 9C are diagrams for describing DTP printing according to an embodiment of the present embodiment;

FIG. 10 is a flow for determining a region to which a treatment liquid according to an embodiment of the present embodiment is discharged;

FIGS. 11A and 11B are diagrams for describing an example of division of an entire image forming region according to an embodiment of the present embodiment;

FIG. 12 is a diagram illustrating an example of a case where an image is formed on a printed material with a white ink;

FIG. 13 is an example of an image prepared by the comparative example;

FIG. 14 is a diagram illustrating an example of an ink adhesion amount;

FIG. 15 is an example of an image prepared according to an embodiment of the present embodiment;

FIG. 16A is an example of a second test chart and FIG. 16B is an example of a transferred image;

FIG. 17 is an example of a case where a streak occurs in an image for transfer;

FIG. 18 is an example of a case of determining an adhesion amount of a treatment liquid;

FIGS. 19A and 19B are diagrams for describing an example of a case where the treatment liquid is spotted to an image forming region;

FIGS. 20A and 20B are diagrams for describing an example of an operation of discharging the treatment liquid; and

FIGS. 21A and 21B are diagrams for describing another example of the operation of discharging the treatment liquid.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A liquid discharge apparatus and a liquid discharge method according to the present embodiment will be described below referring to the drawings. The following embodiments are not limiting the present embodiment and any addition, modification, deletion and the like can be made within a scope in which person skilled in the art can conceive including other embodiments, and any of which is included within the scope of the present embodiment as long as the effect and feature of the present embodiment are demonstrated.

A liquid discharge apparatus according to the present embodiment includes a first discharger that discharges a color ink to a transferring base material that transfers an image to a printed material, a second discharger that discharges a white ink serving as an undercoat of the color ink when the image is transferred to the printed material to the transferring base material, a third discharger that discharges a treatment liquid containing an aggregating agent to the transferring base material, and a control unit that controls discharge of the color ink, the white ink, and the treatment liquid, and the control unit controls to calculate a total adhesion amount of the color ink and the white ink for each predetermined region on the basis of image data, and to discharge the treatment liquid to a region in which the total adhesion amount of the color ink and the white ink exceeds a predetermined threshold.

A liquid discharge method according to the present embodiment includes a first discharge step of discharging a color ink to a transferring base material that transfers an image to a printed material, a second discharge step of discharging a white ink serving as an undercoat of the color ink when the image is transferred to the printed material to the transferring base material, a third discharge step of discharging a treatment liquid containing an aggregating agent to the transferring base material, and a control step of controlling discharge of the color ink, the white ink, and the treatment liquid, and the control unit controls to calculate a total adhesion amount of the color ink and the white ink for each predetermined region on the basis of image data, and to discharge the treatment liquid to a region in which the total adhesion amount of the color ink and the white ink exceeds a predetermined threshold.

Embodiments according to the present embodiments are described below referring to the drawings. Identical or corresponding parts in the drawings are given identical reference numerals, and redundant description is simplified or omitted accordingly. A printed material and a recording medium are both synonymous. In the following description, control by a control unit is mainly described, but the description of the configuration of the liquid discharge apparatus is applied to the configuration of the liquid discharge method by appropriately replacing the control by the control unit with a control step. The printed material and the recording medium may be referred simply as a “medium”.

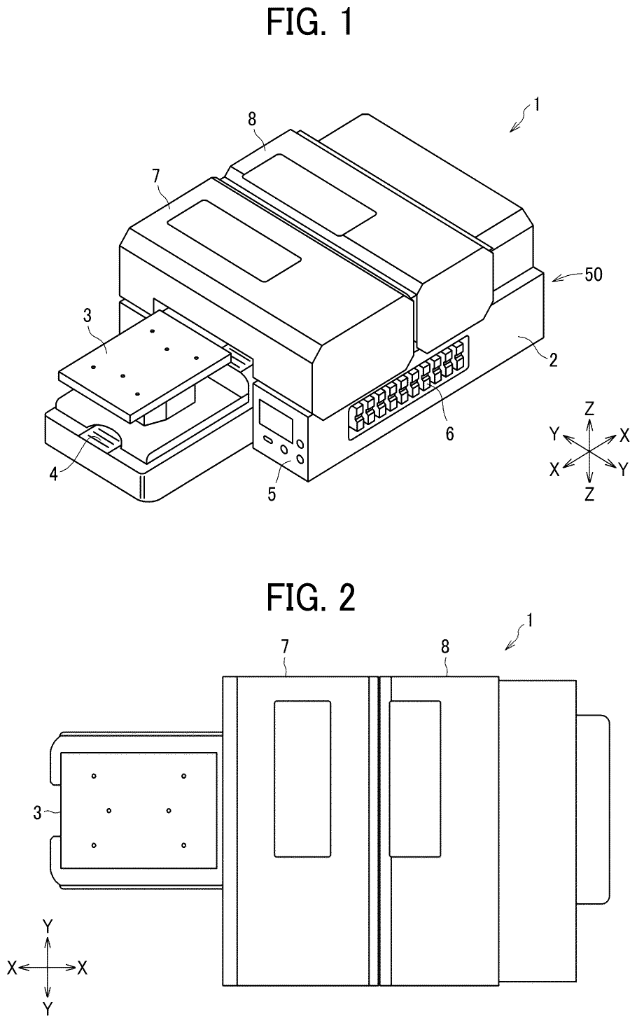

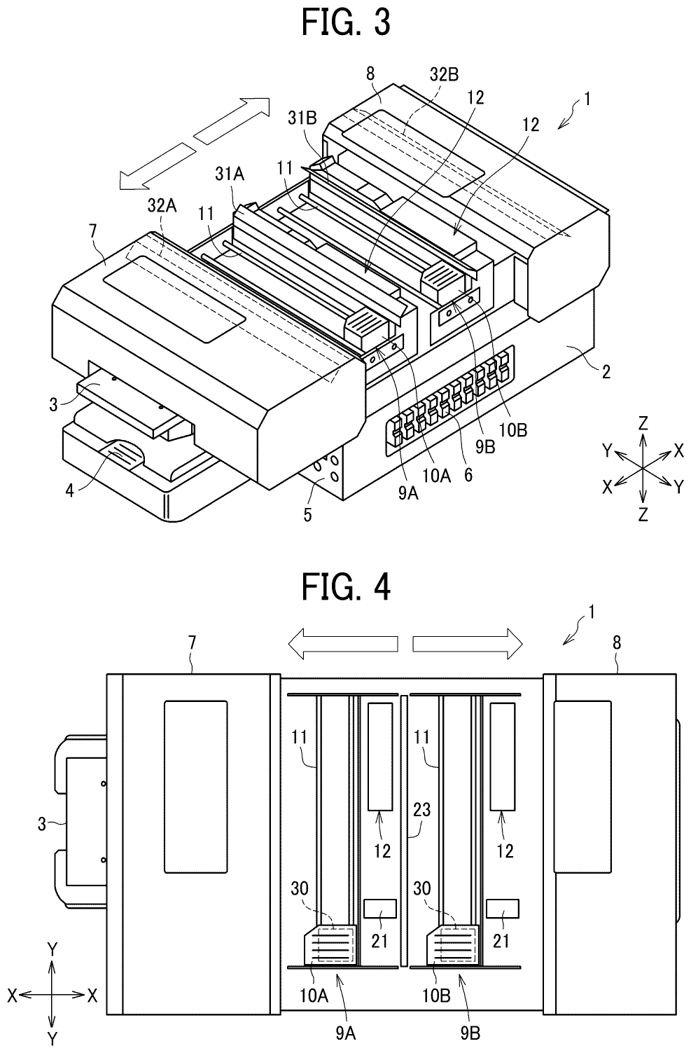

FIG. 1 is a perspective view of a liquid discharge apparatus 1 in a state in which each cover member is closed, and FIG. 2 is a plan view thereof. FIG. 3 is a perspective view of the liquid discharge apparatus 1 in a state in which the cover member is opened, and FIG. 4 is a plan view thereof. A direction X in FIG. 1 is a front-rear direction or a sub-scanning direction of the liquid discharge apparatus, or a conveyance direction of a transferring base material, a direction Y is a width direction or a main-scanning direction of the liquid discharge apparatus, and a direction Z is an up-down direction. The directions X and Y are directions parallel to a liquid discharge surface of the transferring base material arranged on a stage, but may have some error. The directions X, Y, and Z are orthogonal to one another.

As illustrated in FIGS. 1 and 2, the liquid discharge apparatus 1 includes a stage 3 in front of a housing 2. The stage 3 is mounted on a guide rail 4. The guide rail 4 extends in the direction X. A control panel 5 is provided on a front side of the housing 2. An ink cartridge 6 is detachably attached to a side surface of the housing 2. A front cover 7 and a rear cover 8 as cover members are provided above the housing 2.

An upper surface of the stage 3 is a placement surface on which the transferring base material is placed and is flat. The upper surface of the stage 3 is parallel to the directions X and Y. The stage 3 is provided so as to be movable on the guide rail 4 to reciprocate in both directions of the direction X. The stage 3 is provided so as to be elevated in the direction Z. As a result, a height of the transferring base material arranged on the stage 3 is adjustable.

The front cover 7 and the rear cover 8 are provided so as to be movable in both directions in the direction X. A state in FIG. 1 in which the front cover 7 moves rearward and the rear cover 8 moves forward is the state in which each cover is closed. In contrast, a state in FIG. 3 in which the front cover 7 moves forward and the rear cover 8 moves rearward is the state in which each cover is opened. In this manner, by configuring the front cover 7 and the rear cover 8 so as to be slidably opened and closed, an occupied region of the liquid discharge apparatus including an opening/closing region of a cover member can be made smaller as compared with a configuration of opening and closing vertically, for example. The front cover 7 and the rear cover 8 include openings at both ends in the front-rear direction. In a state in which the front cover 7 and the rear cover 8 are closed, the front cover 7 and the rear cover 8 are continuously arranged in the front-rear direction.

As illustrated in FIGS. 3 and 4, an apparatus main body 50 of the liquid discharge apparatus 1 includes the housing 2 and liquid discharge units 9A and 9B mounted on the housing 2. In the present embodiment, in particular, the apparatus main body 50 is a portion of the liquid discharge apparatus 1 other than the front cover 7 and the rear cover 8. The front cover 7 and the rear cover 8 are slidably provided in the direction X with respect to the apparatus main body 50.

The front cover 7 and the rear cover 8 are opened to expose the liquid discharge units in the liquid discharge apparatus 1 to the outside. When the liquid discharge units are exposed to the outside, a maintenance unit 30, a liquid discharge head, and the surroundings thereof can be cleaned, or can a carriage can be replaced. The front cover 7 and the rear cover 8 are closed at the time of image formation. As a result, the liquid discharge units 9A and 9B are covered with the front cover 7 or the rear cover 8 to block access to operation units such as the carriages of the liquid discharge units 9A and 9B from the outside. The liquid discharge units 9A and 9B are arranged in a closed space in the front cover 7 or the rear cover 8, so that an ink mist is prevented from scattering around at the time of a liquid discharge operation, and fans provided on the liquid discharge units 9A and 9B can circulate an airflow in the front cover 7 or the rear cover 8 and circulate the generated ink mist in the front cover 7 or the rear cover 8 to collect.

The liquid discharge apparatus 1 according to the present embodiment includes the two liquid discharge units 9A and 9B in the direction X. The liquid discharge unit 9A discharges a color ink and a white ink. The liquid discharge unit 9B discharges a treatment liquid. The liquid discharged by each of the liquid discharge units 9A and 9B is not limited to the above liquid, and any liquid of the color ink, the white ink, and the treatment liquid may be discharged.

Since the liquid discharge units 9A and 9B have similar configurations, the liquid discharge unit 9A is described below. The liquid discharge unit 9A includes a carriage 10A, a guide rod 11, an electrical unit 12 including a circuit board and an electrical cover, and the maintenance unit 30. The liquid discharge units 9A and 9B or the carriages 10A and 10B are simply referred to as the liquid discharge unit 9 or a carriage 10.

The guide rod 11 extends in the main-scanning direction. The carriage 10 is movable in the main-scanning direction along the guide rod 11. The carriage 10 includes a plurality of liquid discharge heads. The maintenance unit 30 is provided at a position opposed to the guide rod 11, the position outside a liquid discharge region on one side in the right-left direction.

The maintenance unit 30 includes a wiping member that cleans a nozzle surface of the liquid discharge head and a suction mechanism that sucks the nozzle surface. The wiping member may be a wiper made of rubber, or a web made of nonwoven fabric.

An example of a process of forming an image as for the liquid discharge head described above is described.

First, a transferring base material is placed on the stage 3 and conveyed along the guide rail 4. Then, this is conveyed to a front side of the liquid discharge apparatus, and the color ink is discharged to the transferring base material by the liquid discharge unit 9A. Specifically, while the carriage 10A is moved in the main-scanning direction along the guide rod 11, the color ink is discharged from the nozzle provided on the liquid discharge head to the transferring base material in the main-scanning direction. By repeatedly performing this at each position in the sub-scanning direction, the color ink is applied to the transferring base material.

After that, while the stage 3 is moved rearward, the liquid discharge unit 9B discharges the treatment liquid by a similar method. Next, while the stage 3 is moved forward, the white ink is discharged to the transferring base material by the liquid discharge unit 9A by a similar method. As a result, an image for transfer can be formed on the transferring base material.

The liquid discharge apparatus 1 according to the present embodiment can discharge not only the color ink and the white ink but also the treatment liquid. The liquid discharge apparatus 1 according to the present embodiment includes first to third discharger that discharge liquid (the color ink, white ink, and treatment liquid), and the liquid discharge head is an example of the discharger. The treatment liquid used in the present embodiment contains an aggregating agent that aggregates the white ink.

The treatment liquid may be referred to as a pretreatment liquid.

The liquid discharge apparatus 1 according to the present embodiment can also perform direct to garment (DTG) printing. In this case, instead of the transferring base material, a recording medium such as cloth is set on the stage 3 and the liquid is discharged. The liquid discharge apparatus according to the present embodiment is not limited to the above example, and may have a configuration equipped with a liquid discharge head that discharges a treatment liquid on a roll to roll printer.

Next, a comparative example will be described before describing a detailed example of the present embodiment.

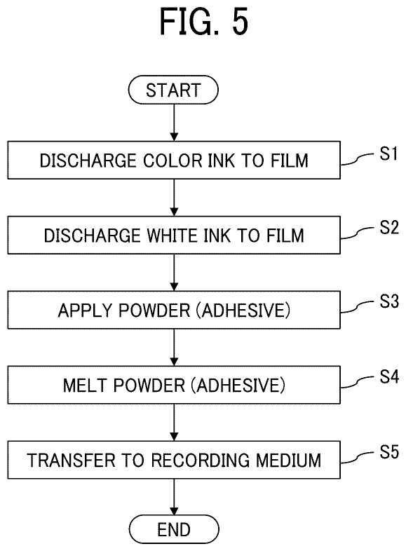

FIG. 5 is a flow illustrating direct to film (DTF) printing of the comparative example.

At S1, a color ink is discharged to a film as a transferring base material.

At S2, a white ink is discharged to the film to which the color ink discharged. On the film, a color ink layer is formed and a white ink layer is formed on the color ink layer.

At S3, a powder (adhesive) is applied to the film. An adhesive layer of the adhesive is formed on the white ink layer. As the adhesive, for example, a hot melt resin powder is used.

At S4, heat treatment is performed to melt the powder.

At S5, an image on a transferring base material is transferred to a printed material (for example, a recording medium), and an image is formed on the printed material. Examples of the printed material include fabric of a T-shirt and a tote bag. In the DTF printing, it is expected to form a high-quality image on the fabric.

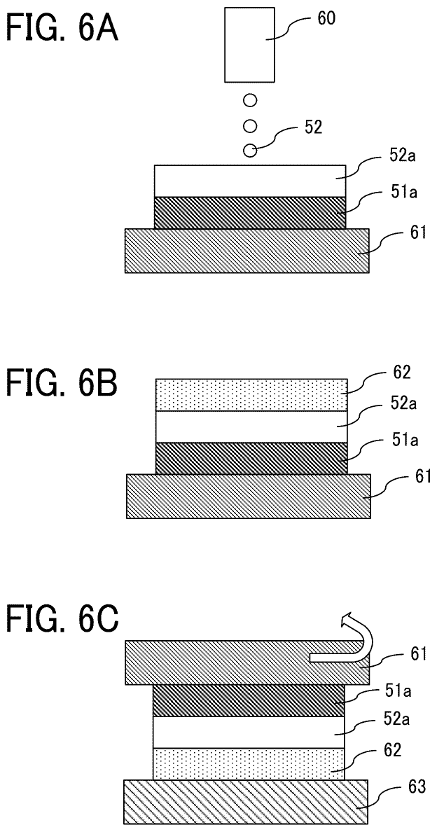

FIGS. 6A to 6C are schematic cross-sectional views for describing the DTF printing of the comparative example.

As illustrated in FIG. 6A, the color ink is discharged to a film 61 as the transferring base material to form a color ink layer 51a, and white ink 52 is further discharged to form a white ink layer 52a.

The color ink and the white ink are discharged by, for example, a liquid discharge head 60.

Since the DTF printing is a printing method in which an image on the film 61 is transferred to the printed material to perform image formation, the image is mirror-inverted on the film 61 to form the color ink layer and the white ink layer. A main reason for discharging the white ink is to prevent an effect of a color of the fabric of the printed material, which is a transfer destination. The white ink layer is used as an undercoat of the color ink layer in the printed material.

Next, as illustrated in FIG. 6B, a powder 62 is applied to the image for transfer on the film 61, and heat is applied to melt the powder 62.

Next, as illustrated in FIG. 6C, a recording medium 63 as the printed material is superimposed on the film 61, and heat and pressure are applied, so that the image on the film 61 is transferred to the recording medium 63. By peeling the film 61, a desired image can be formed on the recording medium 63. Examples of the recording medium 63 include fabric of a T-shirt.

An ink receiving layer is formed on a general film 61, and an amount of ink that can be received by the ink receiving layer has an upper limit value. In the comparative example, the ink might be discharged beyond the upper limit value, and when the upper limit value is exceeded, color mixing of the color ink and the white ink occurs. When the color ink and the white ink are mixed on the film 61, color unevenness occurs, and when the transfer is performed on the recording medium 63 in this state, the color unevenness also occurs in the image after the transfer.

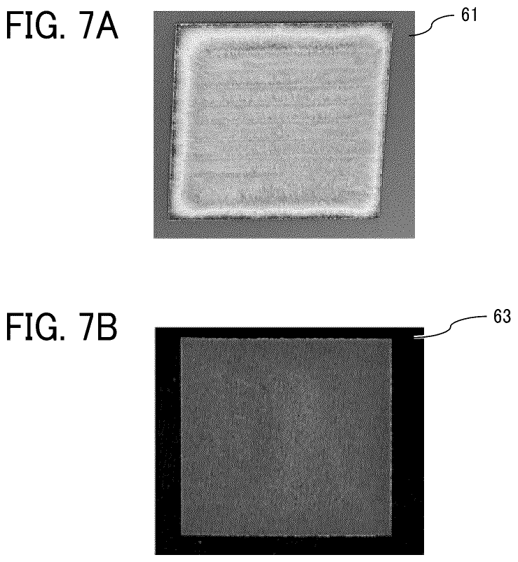

FIGS. 7A and 7B are diagrams for describing an example in a case where the color unevenness occurs in the DTF printing of the comparative example. FIG. 7A is the diagram illustrating a state in which the ink (color ink and white ink) of the upper limit value or more is actually adhered to the film 61. Although it is difficult to see on a paper surface, the color mixing of the color ink and the white ink occurred on the film, and the color unevenness occurred. FIG. 7B is the diagram illustrating a state when it is transferred to the recording medium 63 in the state of FIG. 7A. Although it is difficult to see on the paper surface, the color unevenness also occurred in the image after the transfer to the recording medium. There is a difference in the image between the center and the periphery of the center of the transferred image.

A detailed example of the present embodiment will be described.

A liquid discharge apparatus according to the present embodiment includes a first discharger that discharges a color ink to a transferring base material that transfers an image to a printed material, a second discharger that discharges a white ink serving as an undercoat of the color ink when the image is transferred to the printed material to the transferring base material, a third discharger that discharges a treatment liquid containing an aggregating agent to the transferring base material, and a control unit that controls discharge of the color ink, the white ink, and the treatment liquid.

The control unit in the present embodiment controls to calculate a total adhesion amount of the color ink and the white ink for each predetermined region on the basis of image data, and to discharge the treatment liquid to a region in which the total adhesion amount of the color ink and the white ink exceeds a predetermined threshold.

The color ink, the white ink, and the treatment liquid are discharged to the transferring base material to form an image for transfer. An adhesive is applied to the image for transfer as necessary, and heated to melt the adhesive. The adhesive is preferably a powder, and the powder adhesive is sometimes referred to as a powder and adhesive powder. The printed material is superimposed on the transferring base material, and heating and pressurization are performed as necessary to transfer the image for transfer to the printed material. A step of transferring the image for transfer to the printed material may be referred to as a transfer step.

The adhesive can be appropriately selected, and for example, a hot melt resin powder is used. By applying the adhesive to the transferring base material, a layer of the adhesive is formed. An applying method is not limited in particular and can be selected as appropriate.

The printed material can be appropriately selected, and examples thereof include cloth and fabric of a T-shirt and a tote bag. The printed material may be referred to as a medium and a recording medium.

The treatment liquid may contain an aggregating agent, and can be appropriately selected. The treatment liquid may be referred to as a pretreatment liquid. The aggregating agent can be appropriately selected, and a known aggregating agent can be used. The aggregating agent in the present embodiment aggregates the white ink.

The color ink and the white ink can be appropriately selected, and known ones can be used. The color ink may be one type or a plurality of types.

In the present embodiment, the total adhesion amount of the color ink and the white ink is calculated for each predetermined region on the basis of the image data, and the treatment liquid is discharged to a region in which the total adhesion amount of the color ink and the white ink exceeds a predetermined threshold. That is, on the basis of a determination result for the region in which the treatment liquid is discharged, the treatment liquid is applied only to a region in which color mixing of the color ink and the white ink might occur. Therefore, the treatment liquid can be discharged to a necessary region, color mixing of the color ink and the white ink can be reduced, and deterioration in image quality can be prevented.

In the present embodiment, since the discharge of the treatment liquid can be omitted in a region in which the color mixing of the color ink and the white ink does not occur, a used amount of the treatment liquid can be reduced, and a cost reduction can be expected. In the region in which the color mixing of the color ink and the white ink does not occur, the discharge of the treatment liquid is omitted, so that improvement in productivity can be expected.

The predetermined region can be appropriately selected. The total adhesion amount of the color ink and the white ink for each predetermined region may be, for example, the sum of the adhesion amounts of the color ink and the white ink per unit area.

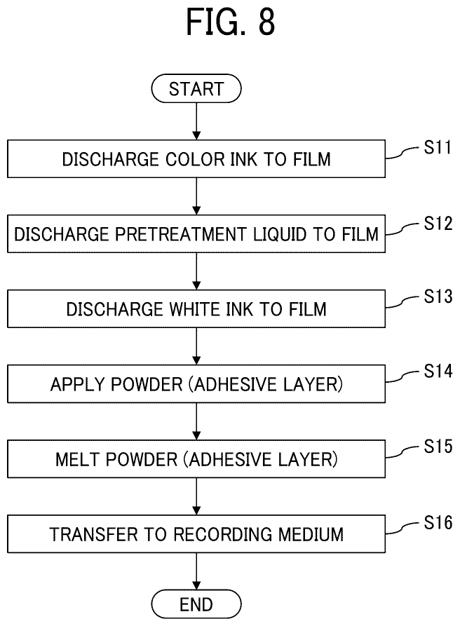

FIG. 8 is an example of a flow of the present embodiment. Here, description of determination processing of the discharge of the treatment liquid is omitted.

At S11, the color ink is discharged to a film as the transferring base material.

At S12, the treatment liquid is discharged to the film to which the color ink is discharged.

At S13, the white ink is discharged to the film to which the color ink and the treatment liquid are discharged. As a result, the image for transfer is formed on the film.

At S14, the powder (adhesive) is applied to the film. An adhesive layer of the adhesive is formed on the white ink layer.

At S15, heat treatment is performed to melt the powder.

At S16, the image for transfer on the film is transferred to the printed material (for example, the recording medium), and an image is formed on the printed material. As with the comparative example, examples of the printed material include fabric of a T-shirt and a tote bag. In the present embodiment, a high-quality image can be formed on the fabric.

The example illustrated in FIG. 8 is a preferred example in the present embodiment. In the above-described example, the color ink, the treatment liquid, and the white ink are discharged in this order, but the present embodiment is not limited thereto, and for example, the color ink, the white ink, and the treatment liquid may be discharged in this order. Note that, in a case of discharging the color ink, the treatment liquid, and the white ink in this order as in the above-described example, the mixture of the color ink and the white ink can be further reduced.

A preferred example in the present embodiment will be described again.

When discharging the treatment liquid to the region in which the total adhesion amount of the color ink and the white ink exceeds a predetermined threshold, the control unit in the present example preferably controls to discharge the color ink, the treatment liquid, and the white ink to the transferring base material in this order.

In this case, by discharging the white ink after discharging the treatment liquid having an effect of aggregating the white ink, the color mixing (mixture) of the color ink and the white ink can be further reduced. In a case of such an example, the treatment liquid may be referred to as a pretreatment liquid.

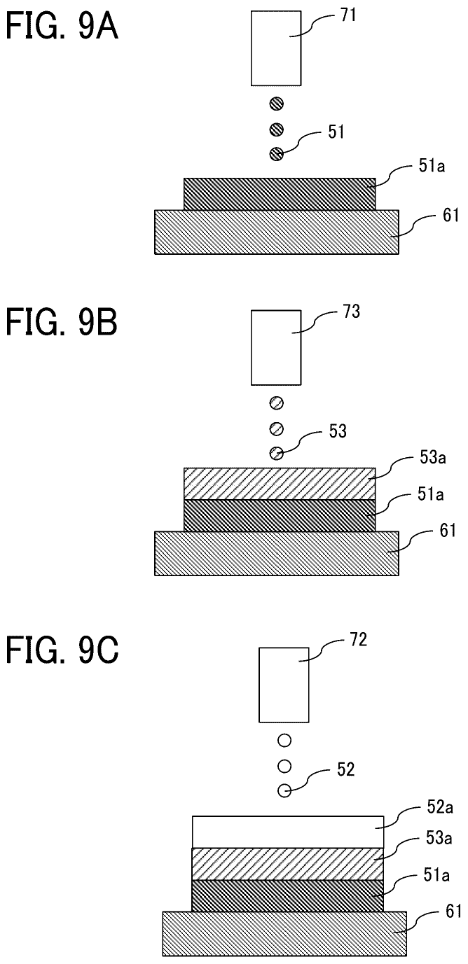

FIGS. 9A to 9C are schematic cross-sectional views for describing an example of a case of forming the image for transfer in the present embodiment. A difference from the above-described comparative example is that, for example, the treatment liquid is discharged.

As illustrated in FIG. 9A, a color ink 51 is discharged to a film 61 as the transferring base material. The color ink 51 discharged to the film 61 forms a color ink layer 51a on the film 61. In the drawing, a droplet of the color ink and the color ink on the film 61 are denoted by different reference numerals. The color ink is discharged by a liquid discharge head 71, which is the first discharger.

Next, as illustrated in FIG. 9B, a treatment liquid 53 is discharged to the film 61. The discharged treatment liquid 53 is applied onto the color ink layer 51a (reference numeral 53a). In the drawing, a droplet of the treatment liquid and the treatment liquid on the film 61 are denoted by different reference numerals. The treatment liquid is discharged by a liquid discharge head 73, which is the third discharger.

Next, as illustrated in FIG. 9C, the white ink 52 is discharged to the film 61. The white ink 52 discharged to the film 61 forms a white ink layer 52a on the film 61. In the drawing, a droplet of the white ink and the white ink on the film 61 are denoted by different reference numerals. The white ink is discharged by a liquid discharge head 72, which is the second discharger.

In the present embodiment, by utilizing the aggregation effect of the treatment liquid, the white ink can be aggregated before the color ink and the white ink are mixed. As a result, color mixing (mixture) of the color ink and the white ink can be prevented.

The transfer step can be performed in the manner similar to the step of the comparative example in FIG. 6.

An adhesive powder 62 is applied to the image for transfer on the film 61, and heat is applied to melt the powder 62. Next, a recording medium 63 as the printed material is superimposed on the film 61, and heat and pressure are applied, so that the image on the film 61 is transferred to the recording medium 63. By peeling the film 61, a desired image can be formed on the recording medium 63.

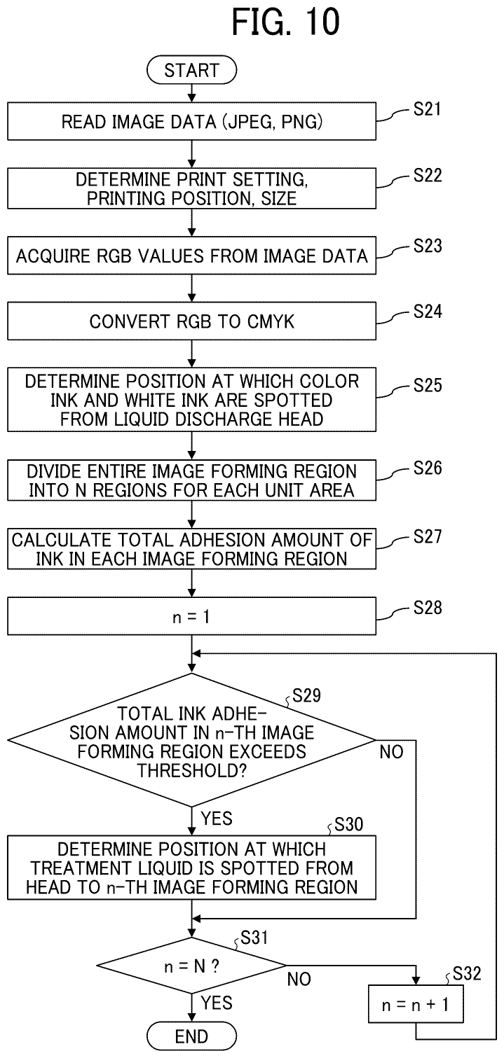

FIG. 10 is a flow illustrating an example of determination processing regarding discharge of the treatment liquid.

At S21, the image data is read. The image data is not limited in particular, and examples thereof include JPEG and PNG.

At S22, a printing condition is determined. Examples of the printing condition include print setting, printing position, and a size.

At S23, RGB values are acquired from the image data.

At S24, the acquired RGB values are converted into CMYK values.

At S25, a position at which the color ink and the white ink are spotted from the liquid discharge head is determined on the basis of the converted CMYK values. The spotting position may be referred to as a position at which the droplet is landed.

At S26, an entire region in which an image is formed is divided into N regions for each predetermined region. In a case of dividing into N regions for each predetermined region, for example, the entire image forming region is divided into N regions in a unit area. N can be appropriately selected. The divided region is also referred to as an image forming region.

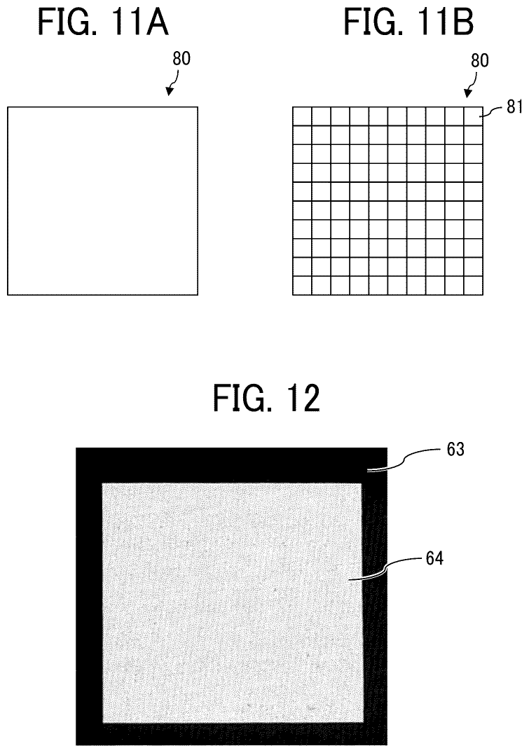

FIGS. 11A and 11B are diagrams for describing an example of a case of dividing the entire region in which the image is formed.

FIG. 11A illustrates the entire image forming region, and the entire image forming region is denoted by reference numeral 80. FIG. 11B illustrates a case where the entire image forming region 80 is divided into N regions, and the divided image forming region is denoted by reference numeral 81. For easy understanding, the entire image forming region 80 and the image forming region 81 are both made square. The entire image forming region 80 is a region in which the color ink and the white ink are discharged. The image forming region 81 is, for example, a region divided by a unit area.

At S27, the total adhesion amount of the ink in each image forming region is calculated. The total adhesion amount of the ink is the total adhesion amount of the color ink and the white ink, and is the sum of the adhesion amount of the color ink and the adhesion amount of the white ink. The total adhesion amount of the ink is also referred to as a total ink adhesion amount. For example, the total ink adhesion amount in the image forming region 81 illustrated in FIG. 11B is calculated.

At S28, n is set to 1.

At S29, the ink adhesion amount is determined for an n-th image forming region. In the determination at S29, it is determined whether the total ink adhesion amount in the n-th image forming region exceeds a threshold. In a case where the total ink adhesion amount exceeds the threshold (in a case where the determination at S29 is YES), S30 is performed. In a case where the total ink adhesion amount does not exceed the threshold (in a case where the determination at S29 is NO), S31 is performed without performing S30. The threshold can be determined by, for example, a test chart to be described later.

In the determination at S29, it is determined whether the total ink adhesion amount in the image forming region exceeds the threshold, but it is possible to change to determine whether this is the threshold or larger. Depending on how the threshold is determined, it is possible to appropriately select whether to determine whether the amount exceeds the threshold or whether the amount is not larger than the threshold.

At S30, a position at which the treatment liquid is spotted from the liquid discharge head to the n-th image forming region is determined. A method for determining the position at which the treatment liquid is spotted can be appropriately selected, and for example, as described later, the treatment liquid may be randomly discharged so that pixels do not overlap each other.

At S31, it is determined whether n is N. In a case where n is N, the flow is terminated, and in a case where n is not N, n is added (S32), and the processing at S29 is repeated. That is, the determination at S29 is performed in the order of n=1, 2, 3, . . . , and N, and it is determined that the image forming region in which the total ink adhesion amount exceeds the threshold is the region in which the treatment liquid is discharged. The “region in which the treatment liquid is discharged” may be referred to also as a “spot region”.

In this manner, the region in which the treatment liquid is discharged is determined, and the treatment liquid is discharged to the determined region. The processing of the flow in FIG. 10 is performed, for example, before S11 in FIG. 8. The processing of the flow in FIG. 10 may be performed between S11 and S12 in FIG. 8, but it is preferable to perform before S11 and determine the region in which the treatment liquid is discharged at the time of S11.

The white ink serves as the undercoat of the color ink when the image is transferred to the printed material. The adhesion amount of the white ink serving as the undercoat can be appropriately selected. For example, the ink may be discharged to the transferring base material in the same amount as the adhesion amount when an image of White (R,G,B)=(255,255,255) is printed on the printed material.

FIG. 12 is a diagram illustrating an example of a case where an image is formed with White (R,G,B)=(255,255,255) on a black T-shirt. The illustrated example is an example of a case of transferring the image on the film 61 to which only white ink is discharged to form an image 64 on the black T-shirt, which is the recording medium 63. As illustrated, the black color of the recording medium 63 is hidden. With such a white ink image 64, even if the color ink layer is formed on the image 64, a desired image can be formed on the recording medium 63 without being affected by the color of the fabric of the black T-shirt.

The image 64 is an example of an image for specifying an adhesion amount for specifying the adhesion amount of the white ink, and examples thereof include a solid image as illustrated in the drawing.

The above-described preferred example of the adhesion amount of the white ink will be described again.

It is preferable that the adhesion amount of the white ink is determined by a method for specifying the white ink adhesion amount described below, and the control unit controls to discharge the white ink with the adhesion amount determined by the method for specifying the white ink adhesion amount described below.

### Method for Specifying Adhesion Amount of White Ink

The white ink is discharged to the transferring base material with any adhesion amount to form the image for specifying the adhesion amount, the image for determining the adhesion amount is transferred to the printed material, and the adhesion amount that is not affected by the color of the printed material is specified by any determination method.

In this manner, the image on the printed material can be prevented from being affected by the color of the printed material, and an image with high color reproducibility can be formed.

Next, a comparison between the image prepared in the comparative example and the image prepared in the example of the present embodiment will be described with reference to the drawings. The actually prepared image is a color image, but for convenience, the drawing is illustrated in black and white.

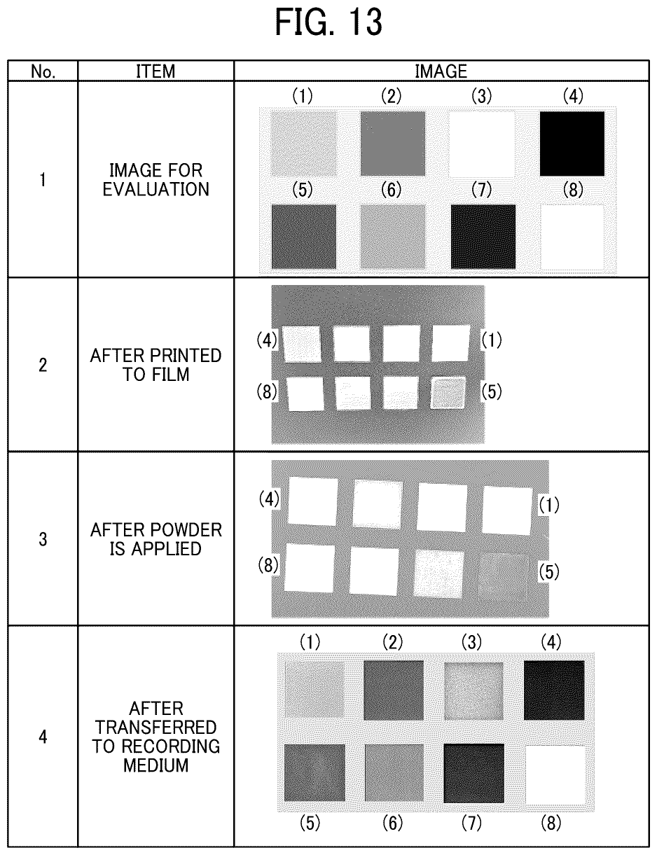

FIG. 13 is a diagram for describing the comparative example. The example illustrated in FIG. 13 is, for example, the example in a case of preparing as illustrated in FIGS. 5 and 6A to 6C, and an image was formed without using the treatment liquid. In FIG. 13, No. 1 is image data for evaluation, No. 2 is an image for transfer formed on a film (transferring base material), No. 3 is a state after powder application, and No. 4 is a state after transferring an image for transfer to a recording medium (printed material). Since it is mirror-inverted to be printed on the film, (1) to (8) of No. 2 and No. 3 are right left reversed with respect to (1) to (8) of No. 1 and No. 4. In No. 2 and No. 3, only (1), (4), (5), and (8) are displayed from the viewpoint of visibility.

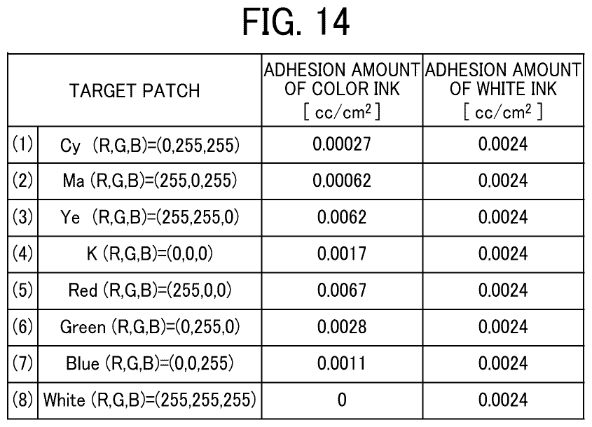

FIG. 14 is a diagram for describing an image (patch) for evaluation in the example illustrated in FIGS. 13. (1) to (8) in FIG. 14 correspond to (1) to (8) of No. 1 in FIG. 13, respectively.

The image (patch) for evaluation was a solid image of 4 cm×4 cm. An adhesion amount of color ink of each patch is a value illustrated in FIG. 14, and an adhesion amount of white ink serving as an undercoat is the same value in each patch, and is the value illustrated in FIG. 14. The patch (8) is a white image as a reference example. Therefore, the adhesion amount of color ink is 0.

In the comparative example illustrated in FIG. 13, although it is difficult to see because it is a monochrome paper surface, the color ink and the white ink were mixed in the patches of (3) Ye, (5) Red, and (6) Green, and color unevenness occurred. The patch (the lowest left) of No. 4 (5) Red in FIG. 13 is particularly easily understood, and the image is different between the center and the outer periphery of the patch.

In the comparative example illustrated in FIG. 13, there was a patch in which color mixing of the color ink and the white ink occurred even at the time of No. 2 and No. 3. In particular, in the patch (the lowest right) of No. 2 (5) Red, such color unevenness that it can be confirmed that the white ink is shifted to the outer periphery of the patch occurred. In the comparative example, it was not in a state in which the color ink layer and the white ink layer were clearly separated on the film, and there was the patch in which the color ink and the white ink were mixed, and the color ink layer and the white ink layer were deviated. Therefore, in the comparative example, the white ink layer does not function as the undercoat, and an image quality deteriorates. Therefore, the color unevenness occurred in some images (No. 4) after the transfer.

As for the patches of (3) Ye, (5) Red, and (6) Green in which the color unevenness occurred, the adhesion amount of the color ink is large with reference to FIG. 14. As illustrated in the drawing, the adhesion amount of the color ink is 2.8×10⁻³ cc/cm² to 6.7×10⁻³ cc/cm² in (3), (5), and (6), which is equal to or more than the adhesion amount of the white ink (2.4×10⁻³ cc/cm²). From this result, it is considered that the total adhesion amount of the color ink and the white ink is so large that an ink receiving layer of the film (transferring base material) cannot receive the ink, and the ink is likely to smear.

From the above knowledge, the example of the present embodiment was carried out in consideration of the total ink adhesion amount.

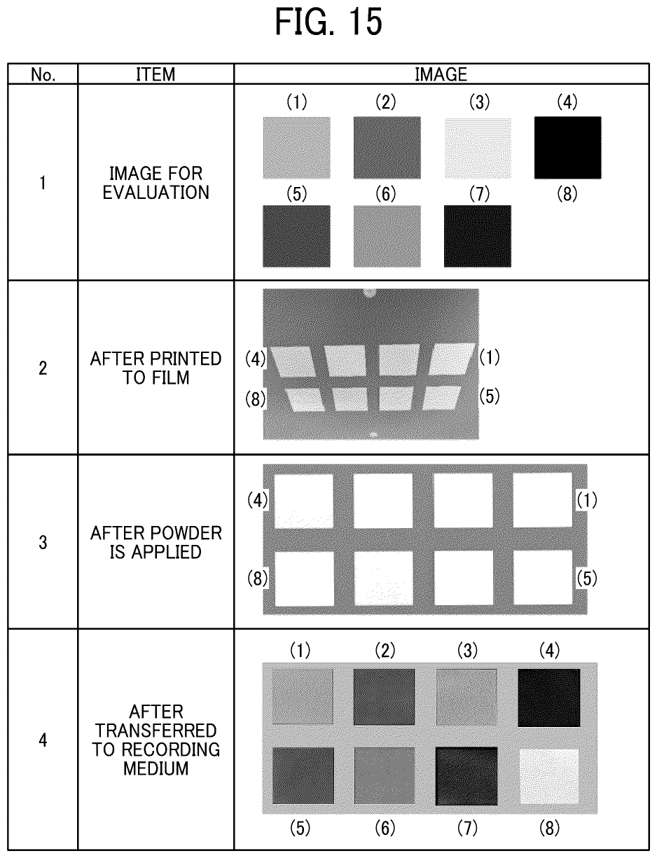

FIG. 15 is a diagram for describing an example of the present embodiment. The example illustrated in FIG. 15 is, for example, an example in a case of preparing as illustrated in FIGS. 8 to 10, and an image was formed using the treatment liquid. (1) to (8) of No. 1 in FIG. 15 correspond to (1) to (8) in FIG. 14, respectively. In the example of the present embodiment, as in the comparative example, the image (patch) for evaluation was a solid image of 4 cm×4 cm. An adhesion amount of color ink of each patch is a value illustrated in FIG. 14, and an adhesion amount of white ink serving as an undercoat is the same value in each patch, and is the value illustrated in FIG. 14. The patch (8) is a white image as a reference example. Therefore, the adhesion amount of color ink is 0.

In the present example, as for the patches of (3) Ye, (5) Red, and (6) Green in which the color unevenness occurred in the comparative example, the treatment liquid was discharged between the discharge of the color ink and the discharge of the white ink. An adhesion amount of the treatment liquid in the present example was 7.9×10⁻⁵ cc/cm². In the result of the present example illustrated in FIG. 15, the color mixing of the color ink and the white ink did not occur in all the patches. In FIG. 15, the color mixing of the color ink and the white ink could be prevented in all of the image for transfer formed on the film (No. 2), the image after powder application (No. 3), and the image after transfer (No. 4). Therefore, an excellent image could be formed on the recording medium.

In the present example, attention was paid to the total ink adhesion amount at a boundary between the patch in which the color unevenness occurred and the patch in which the color unevenness did not occur in the comparative example, a threshold of the total ink adhesion amount was provided, and the treatment liquid was discharged in a case where the threshold was exceeded. By discharging the treatment liquid in the patch in which the total ink adhesion amount was excessive (for example, the patches of (3) Ye, (5) Red, and (6) Green of the comparative example), the color mixing between the color ink and the white ink could be reduced, and the color unevenness due to the color mixing could be reduced. It is not necessary to take measures of reducing the adhesion amount of the ink in order to reduce the color mixing of the color ink and the white ink, and since the adhesion amounts of the color ink and the white ink are maintained, a color gamut and a size can be maintained.

From the above examination, it was found that the treatment liquid may be discharged in a case where the total ink adhesion amount was excessive. It is determined whether the total ink adhesion amount is excessive for each predetermined region. In this manner, the determination can be made uniformly without distinguishing colors.

A predetermined threshold can be determined as appropriate. In the results of FIGS. 13 and 14, the color mixing of the color ink and the white ink did not occur in the patches other than (3) Ye, (5) Red, and (6) Green. Therefore, for example, the total ink adhesion amount of (4) K patch having the largest total ink adhesion amount among the patches in which the color mixing did not occur can be adopted. The total ink adhesion amount of (4) K patch is 4.1×10⁻³ cc/cm², which is the sum of the adhesion amount of the color ink of 1.7×10⁻³ cc/cm² and the adhesion amount of the white ink of 2.4×10⁻³ cc/cm². Therefore, for example, 4.1×10⁻³ cc/cm² is set as a predetermined threshold of the total ink adhesion amount.

Next, another example of determining a predetermined threshold of the total ink adhesion amount will be described. In the present example, a predetermined threshold is determined using a first test chart described below.

A predetermined threshold to be compared with the total adhesion amount of the color ink and the white ink is determined by a first specifying method described below on the basis of the first test chart described below, and the control unit controls the discharge of the treatment liquid using a predetermined threshold determined by the specifying method described below.

### First Test Chart

An adhesion amount of the white ink is set to be constant, an adhesion amount of the color ink is changed stepwise, and the color ink and the white ink are discharged in this order to the transferring base material to prepare a plurality of test patches, which is taken as a first test chart.

### First Specifying Method

In the first test chart, it is determined whether the mixture of the color ink and the white ink occurs by any determination method, a boundary between the test patch in which the mixture occurs and the test patch in which the mixture does not occur is obtained, and the total adhesion amount at the boundary is set as the predetermined threshold.

The first test chart is the test chart in which the adhesion amount of the color ink is assigned (changed) stepwise while the adhesion amount of the white ink is set to be constant. From the viewpoint of preventing the influence of the color of the recording medium 63, the white ink is preferably discharged to a region in which an image is to be formed. Therefore, the adhesion amount of the white ink applied to the entire region in which the image is to be formed is set to a constant value. In this state, the test chart in which the adhesion amount of the color ink is gradually assigned is prepared, and the above first specifying method is performed, so that the total ink adhesion amount that is the boundary of whether the mixture of the color ink and the white ink occurs on the transferring base material can be specified.

In the first test chart, the method for determining whether the color ink and the white ink are mixed (any determination method described above) is not limited in particular, and can be appropriately selected. For example, the determination may be made visually, or the determination may be made by measuring the color unevenness with any measuring device. The first test chart includes a plurality of test patches. The first test chart is an image as No. 2 in FIG. 13, for example, and it is possible to determine by visual observation or color unevenness measurement with the measuring device in any of the states of Nos. 2 to 4 in FIG. 13, so that all patterns such as No. 3 and No. 4 can be adopted.

According to the present example, it is possible to optimize the threshold used for determining whether to discharge the treatment liquid, and to improve the accuracy of the determination. In the present example, the treatment liquid can be used more efficiently, and the color unevenness due to the mixture of the color ink and the white ink can be further reduced.

Next, an example of specifying the adhesion amount of the treatment liquid will be described. In the present example, the adhesion amount of the treatment liquid is specified using a second test chart described below.

The control unit controls the discharge of the treatment liquid on the basis of the adhesion amount of the treatment liquid determined by the second specifying method described below using the second test chart described below.

### Second Test Chart

An adhesion amount of the color ink and an adhesion amount of the white ink are set to be constant, the adhesion amount of the treatment liquid is changed stepwise, and the color ink, the treatment liquid, and the white ink are discharged in this order to the transferring base material to prepare a plurality of test patches, which is taken as a second test chart.

### Second Specifying Method

In the second test chart, it is determined whether the mixture of the color ink and the white ink occurs by any determination method, a boundary between the test patch in which the mixture occurs and the test patch in which the mixture does not occur is obtained, and the adhesion amount of the treatment liquid at the boundary is set as the adhesion amount of the treatment liquid at the time of the image formation.

The term “at the time of image formation” as used herein refers to the time when discharging the treatment liquid when forming an image for transfer on the transferring base material.

The second test chart is the test chart in which the adhesion amount of the treatment liquid is assigned (changed) stepwise while the adhesion amounts of the color ink and the white ink are set to be constant. By preparing the test patch in which the adhesion amount of the treatment liquid is assigned stepwise, it is possible to specify the adhesion amount of the treatment liquid that is a boundary of whether the mixture of the color ink and the white ink occurs on the transferring base material in a case where the treatment liquid is used.

In the second test chart, the method for determining whether the color ink and the white ink are mixed (any determination method described above) is not limited in particular, and can be appropriately selected. For example, the determination may be made visually, or the determination may be made by measuring the color unevenness with any measuring device.

According to the present example, the adhesion amount of the treatment liquid that can prevent the color mixing of the color ink and the white ink can be determined, the treatment liquid can be used more efficiently, and the color unevenness due to the mixture of the color ink and the white ink can be further reduced.

The sum of the adhesion amounts of the color ink and the white ink (total ink adhesion amount) when preparing the second test chart is set to be larger than the threshold used for determining whether to discharge the treatment liquid. In the second test chart, the total ink adhesion amount with which the mixture of the color ink and the white ink occurs in a case where the treatment liquid is not discharged is defined, and the adhesion amount of the treatment liquid is assigned stepwise to prepare each test patch.

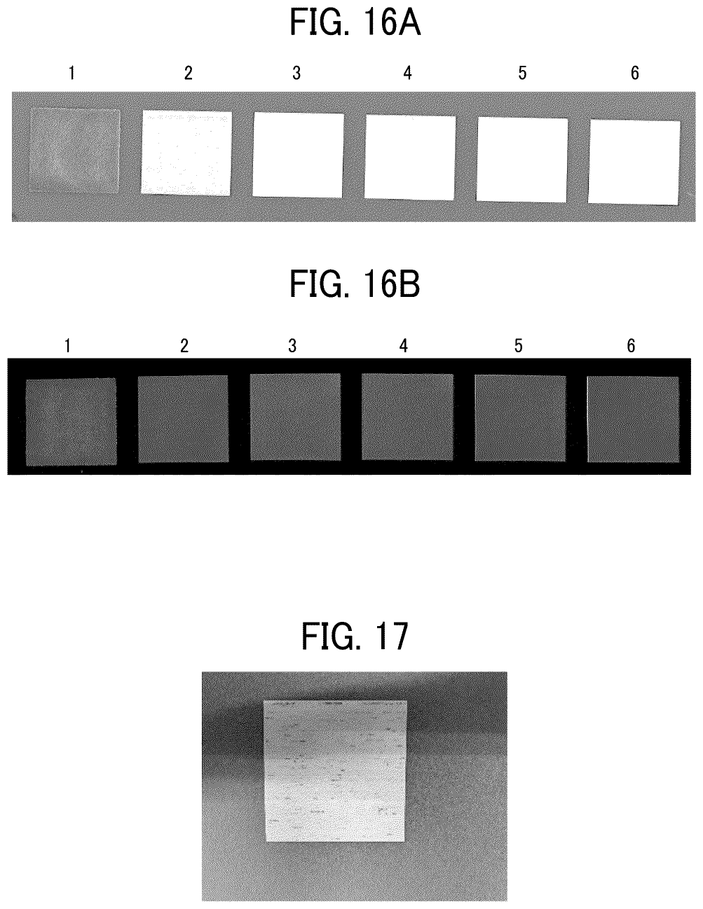

FIGS. 16A and 16B are diagrams illustrating an example of the second test chart. In the second test chart of the present example, Red is used as the color ink, the adhesion amount of the treatment liquid is assigned stepwise to prepare the test patches. FIG. 16A is the second test chart in a state in which the test patch is prepared on the transferring base material to form an image for transfer. FIG. 16B illustrates a state after the image for transfer in FIG. 16A is transferred to the recording medium.

The adhesion amounts of the treatment liquid are set to 0 cc/cm², 4.1×10⁻⁵ cc/cm², 7.9×10⁻⁵ cc/cm², 1.2×10⁻⁴ cc/cm², 1.6×10⁻⁴ cc/cm², and 2.0×10⁻⁴ cc/cm² from the left to the right of the paper surface, respectively.

The adhesion amounts of the color ink and the white ink are the same in any test patch. In the present example, the values illustrated in (5) of FIG. 14 are used.

In the leftmost patch (1 in the drawings) in FIGS. 16A and 16B, since the treatment liquid is not discharged, the mixture of the color ink and the white ink occurs, and the color unevenness occurs. With reference to FIG. 16A, the mixture of the color ink and the white ink could be visually confirmed also in the second patch (2 in the drawing) from the left side. As a result of the visual confirmation, since the mixture of the color ink and the white ink did not occur in the third patch (3 in the drawing) from the left side, it can be determined that the adhesion amount of the treatment liquid in the third to sixth patches from the left side is appropriate. This corresponds to the second specifying method described above.

In the present example, the treatment liquid is discharged with the adhesion amount of the treatment liquid in the third to sixth patches from the left side to form the image for transfer. The adhesion amount is not limited to the adhesion amount of the treatment liquid of each patch, and the adhesion amount can be appropriately selected within the range of the adhesion amount of the treatment liquid in the third to sixth patches. For example, a numerical value between the third and fourth adhesion amounts may be used.

From the viewpoint of preventing the mixture of the color ink and the white ink, also in a case where the second test chart of the present example is used, the treatment liquid may be discharged with the adhesion amount exceeding the adhesion amount of the treatment liquid in the sixth patch. In contrast, when the treatment liquid is excessive, a streak might occur in an image when the image for transfer is formed on the transferring base material. When the streak occurs in the image, the image quality of the image after transfer might be deteriorated.

FIG. 17 is a diagram illustrating an example of a case where the treatment liquid is excessive, the diagram illustrating an image for transfer formed on the transferring base material. In the illustrated example, the treatment liquid is excessive, and the streak occurs in the image for transfer. In the illustrated example, the adhesion amount of the treatment liquid was set to 1.0×10⁻³ cc/cm². It is considered that as the white ink is pulled by the treatment liquid, a region in which the white ink is not adhered at all is generated and appears as the streak.

By setting the adhesion amount of the treatment liquid to an optimum value, the color unevenness due to the mixture of the color ink and the white ink can be reduced while preventing shortage or excessive discharge of the treatment liquid. By using the second test chart, not only the adhesion amount of the treatment liquid that can reduce the mixture of the color ink and the white ink but also the adhesion amount of the treatment liquid that can prevent the streak caused by the excessive discharge of the treatment liquid can be selected.

Next, as for a method for determining the adhesion amount of the treatment liquid, an example other than the above will be described.

In the present example, the adhesion amount of the treatment liquid is determined on the basis of a ratio between the adhesion amount of the treatment liquid and the total ink adhesion amount (total adhesion amount of the color ink and white ink).

The control unit in the present example controls the discharge of the treatment liquid so that the adhesion amount of the treatment liquid is 1/1000 to 1/10 with respect to the sum of the adhesion amount of the color ink and the adhesion amount of the white ink in the region in which the treatment liquid is discharged. By setting the adhesion amount of the treatment liquid to the optimum value in this manner, the color unevenness due to the mixture of the color ink and the white ink can be reduced while preventing the shortage or excessive discharge of the treatment liquid.

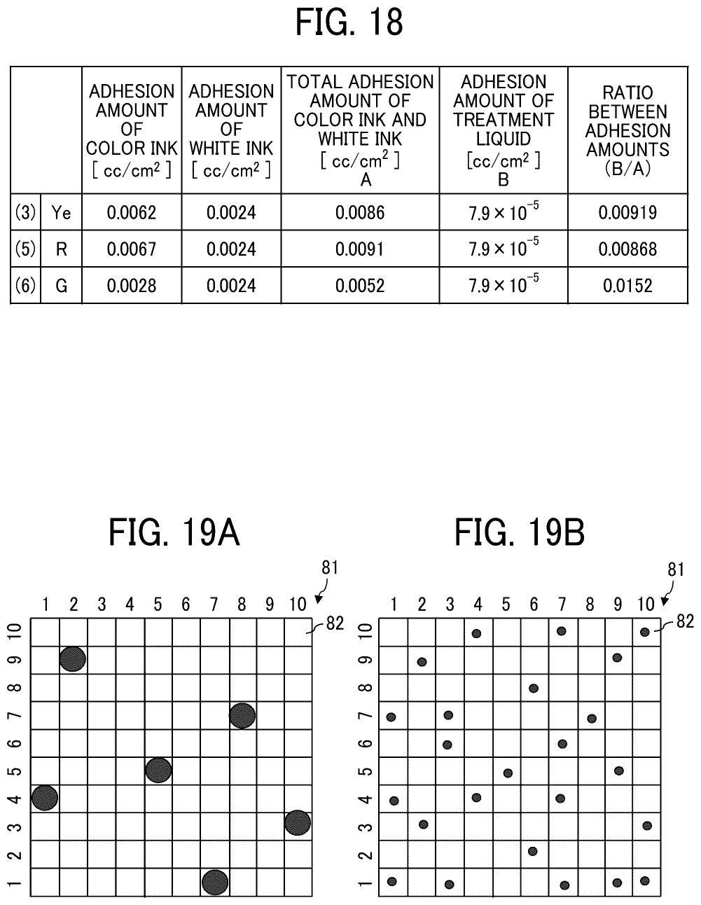

FIG. 18 is a diagram illustrating an example of a case where the adhesion amount of the treatment liquid is determined in the present example.

In the illustrated example, in the comparative example illustrated in FIG. 14 above, the adhesion amount of the treatment liquid in a case of using the treatment liquid in (3) Ye, (5) Red, and (6) Green in which the mixture of the color ink and the white ink occurred was defined. A ratio (B/A) of the adhesion amounts is a ratio of the adhesion amount of the treatment liquid (B in the drawing) to the total ink adhesion amount (total adhesion amount of color ink and white ink, A in the drawing). The adhesion amount of the treatment liquid is determined so that the ratio of the adhesion amounts is 1/1000 to 1/10. As illustrated as B, the adhesion amount of the treatment liquid in the present example was 7.9×10⁻⁵ cc/cm².

When the treatment liquid was discharged with this adhesion amount, it was possible to prevent the mixture of the color ink and the white ink in the image for transfer on the transferring base material. No streak occurred in the image for transfer on the transferring base material. When the image was transferred to the printed material, the color unevenness did not occur.

Therefore, according to the present example, the color unevenness due to the mixture of the color ink and the white ink can be reduced while preventing the shortage or excessive discharge of the treatment liquid. In the present example, it is possible to save time and effort for preparing the test chart and determining the test chart.

Next, an aspect in which the treatment liquid is discharged to the image forming region determined as the target to which the treatment liquid is discharged will be described.

At S30 of the flow in FIG. 10 described above, a position at which the treatment liquid is spotted (landed) from the liquid discharge head to the n-th image forming region is determined. In a case where the treatment liquid is spotted to the n-th image forming region from the liquid discharge head, the position at which the treatment liquid is landed can be appropriately selected. For example, the image forming region is divided into pixels that are units in which a droplet of the treatment liquid is landed, and the pixel to which the treatment liquid is landed is selected. In this case, the treatment liquid may be landed to all the pixels in the image forming region, but the treatment liquid might be excessively applied depending on a size of the droplet of the treatment liquid. When a place where the treatment liquid is particularly concentrated is generated, the white ink is easily aggregated at the place, and application unevenness of the white ink might occur. Therefore, selection of the pixel to which the treatment liquid is landed in the image forming region and selection of the droplet size of the treatment liquid are important.

Therefore, in the present example, the size of the droplet (this may also be referred to as a drop size or a droplet size) is defined, and pixels to which it is discharged are randomly selected so that the pixels to which the treatment liquid is landed in the image forming region do not overlap.

That is, the control unit in the present example sets the size of the droplet of the treatment liquid to 12 pL or smaller, divides the region in which the treatment liquid is discharged by determination of the threshold into pixels that are units to which the droplet of the treatment liquid is landed, randomly selects the pixels so that the pixels to which the droplet of the treatment liquid is landed do not overlap, and discharges the treatment liquid to the selected pixels.

In this manner, it is possible to prevent the treatment liquid from locally condensed, to reduce the application unevenness of the white ink, and the color unevenness is less likely to occur. In a case of applying the treatment liquid to all the pixels, the amount of the treatment liquid might be excessive, and an abnormal image such as the streak might occur. Therefore, as in the present example, by further finely dividing the image forming region into pixel units, thinning out the pixels, and spotting the treatment liquid, it is possible to prevent the amount of the treatment liquid from becoming excessive.

FIGS. 19A and 19B are diagrams for describing the present example.

FIG. 19A illustrates an example of a case where the pixels are randomly selected in the image forming region 81 (region in a case where the entire image forming region 80 in FIG. 11A is divided into N regions) and the size of the droplet is set to 12 pL.

In the drawing, the image forming region 81 is divided into 10×10 pixels, that is, 100 pixels, and the pixels are denoted by reference numeral 82. The treatment liquid is discharged to the randomly selected pixels 82, and the pixels to which it is discharged are represented by black circles.

FIG. 19B illustrates an example of a case where the pixels are randomly selected as in FIG. 19A, the example of a case where the size of the droplet is set to 3 pL.

In both FIGS. 19A and 19B, the size of the droplet is set to 12 pL or smaller, the pixels are randomly selected so that the pixels to which the droplet of the treatment liquid is landed do not overlap, and the treatment liquid is discharged to the selected pixels. As a result, the application unevenness of the white ink can be reduced, and the occurrence of color unevenness can be prevented.

In the present example, it is preferable to adjust a pixel coverage ratio according to the size of the droplet. The pixel coverage ratio is a ratio in a case where the number of all pixels in the image forming region 81 is a denominator and the number of pixels to which the treatment liquid is landed is a numerator. The pixel coverage ratio in FIG. 19A is 6% (six pixels in 100 pixels), and the pixel coverage ratio in FIG. 19B is 24% (24 pixels in 100 pixels). In FIG. 19A, the size of the droplet is set to relatively large 12 pL, therefore, the pixel coverage ratio is adjusted to be low and set to 6%. In contrast, in FIG. 19B, the size of the droplet is set to relatively small 3 pL, therefore, the pixel coverage ratio is adjusted to be high and set to 24%. In this manner, it is possible to prevent the treatment liquid from locally condensed, and the color unevenness is less likely to occur.

Next, an example of an operation of discharging the treatment liquid will be described.

In a case where there are both the region in which the treatment liquid is discharged and the region in which the treatment liquid is not discharged, it is preferable to skip the scanning of a carriage for treatment liquid (not to allow to scan) in the region in which the treatment liquid is not discharged.

The liquid discharge apparatus according to the present example includes the carriage for treatment liquid equipped with the third discharger, the carriage for treatment liquid discharges the treatment liquid while performing scanning, the control unit allows the carriage for treatment liquid to scan a portion where there is the region in which the treatment liquid is discharged, and does not allow the carriage for treatment liquid to scan a portion where there is no region in which the treatment liquid is discharged.

According to the present example, unnecessary scanning can be omitted by skipping the scanning of the carriage for treatment liquid, and productivity can be improved.

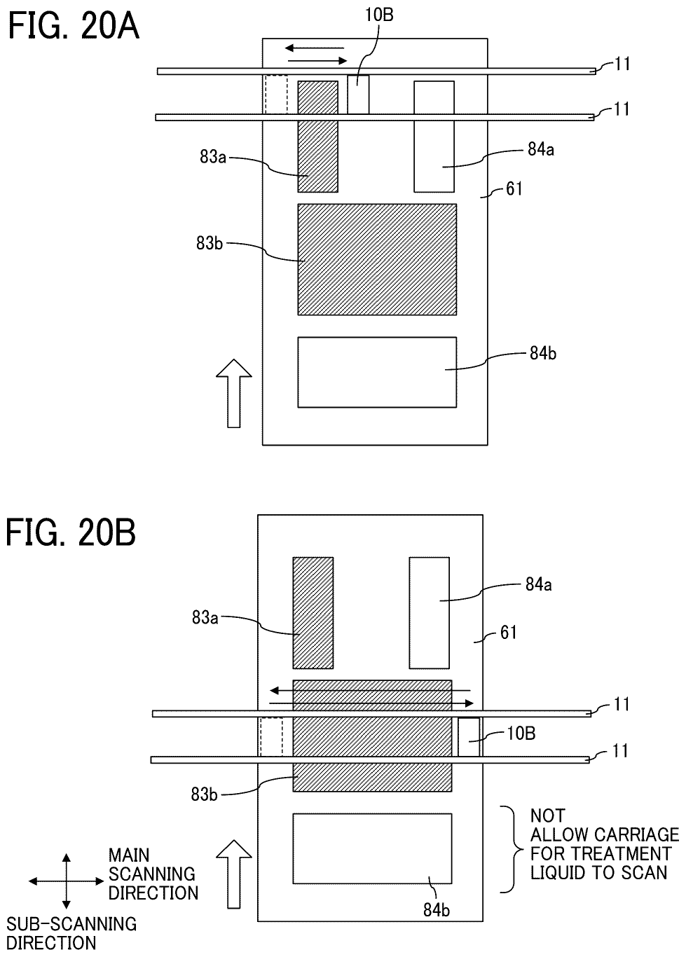

FIGS. 20A and 20B are schematic views for describing the present example. FIG. 20A is a diagram describing a state of discharging the treatment liquid to the film 61. FIG. 20B is a diagram illustrating a state in which time elapses from FIG. 20A. A white arrow in the drawings indicates a conveyance direction of the film 61 (transferring base material). A right-left direction of the paper surface is the main-scanning direction, which is the scanning direction of the carriage. An up-down direction of the paper surface is the sub-scanning direction, and also corresponds to the conveyance direction of the film 61.

The film 61 is placed on the stage 3 (which may also be referred to as a platen) and conveyed. The carriage for treatment liquid in the present example is the carriage 10B, and is equipped with the third discharger that discharges the treatment liquid. The carriage 10B discharges the treatment liquid to the film 61 while reciprocally scanning on the film 61 along the guide rod 11 in the main-scanning direction. A black arrow in the drawings schematically indicates a moving direction of the carriage 10B.

On the film 61, there are regions 83a and 83b as the regions in which the treatment liquid is discharged, and regions 84a and 84b as the regions in which the treatment liquid is not discharged. In a case where the regions 83a and 83b are described without distinction, they are referred to as the regions 83, and in a case where the regions 84a and 84b are described without distinction, they are referred to as the regions 84. The region 83 and the region 84 in the present example both discharge the color ink and the white ink.

As illustrated in FIG. 20A, in the region 83a in which the treatment liquid is discharged, the control unit allows the carriage 10B to scan to discharge the treatment liquid to the region 83a. In contrast, in the region 84a in which the treatment liquid is not discharged, the control unit skips the scanning of the carriage 10B and does not allow the carriage 10B to scan. This is indicated by the black arrow in the drawing. That is, the black arrow is displayed in the region 83a in which the treatment liquid is discharged, and the carriage 10B is allowed to scan. In contrast, in the region 84a in which the treatment liquid is not discharged, the black arrow is not displayed, and the scanning of the carriage 10B is skipped (not allowed to scan).

As illustrated in FIG. 20B, in the region 83b in which the treatment liquid is discharged, the control unit allows the carriage 10B to scan to discharge the treatment liquid to the region 83b. As illustrated, the black arrow is a long arrow corresponding to the region 83b, and the control unit allows the carriage 10B to scan corresponding to the region 83b. In contrast, in the region 84b in which the treatment liquid is not discharged, the scanning of the carriage 10B is not performed.

In this manner, in FIG. 20A, the scanning of the carriage 10B is performed only in the region 83a, and the scanning of the carriage 10B can be skipped in the region 84a. In FIG.

20B, similarly, the scanning of the carriage 10B is performed only in the region 83b, and the scanning of the carriage 10B can be skipped in the region 84b. As a result, the unnecessary scanning can be omitted, and the productivity can be improved.

Next, another example of the operation of discharging the treatment liquid will be described.

In the present example, the color ink and the treatment liquid are discharged in parallel, or the white ink and the treatment liquid are discharged in parallel. To discharge in parallel may also be referred to as to simultaneously discharge.

The liquid discharge apparatus according to the present example includes a carriage for ink equipped with the first discharger and the second discharger, the carriage for treatment liquid equipped with the third discharger, and a conveyor that conveys the transferring base material, in which the conveyor can convey the transferring base material in a forward path and a backward path, the carriage for ink and the carriage for treatment liquid perform reciprocating scanning in a direction perpendicular to the conveyance direction of the transferring base material, and the control unit allows the carriage for ink and the carriage for treatment liquid to scan in the forward path or the backward path of the transferring base material to discharge the color ink and discharge the treatment liquid in parallel, or discharge the white ink and discharge the treatment liquid in parallel.

According to the present example, the productivity can be improved.

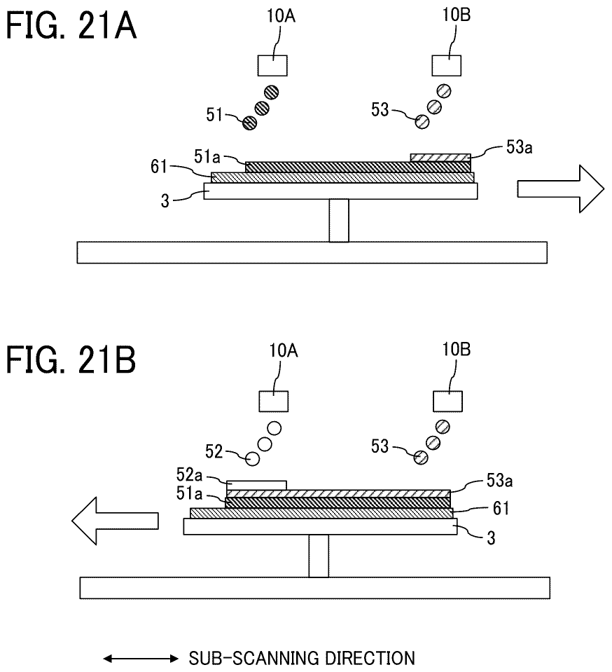

FIGS. 21A and 21B are schematic cross-sectional views for describing the present example. FIG. 21A is an example of a case where the discharge of the color ink and the discharge of the treatment liquid are performed in parallel in the forward path. FIG. 21B is an example of a case where the discharge of the white ink and the discharge of the treatment liquid are performed in parallel in the backward path.

The film 61 is placed on the stage 3 (which may also be referred to as a platen) and conveyed. A white arrow in the drawings indicates the conveyance direction of the film 61. The conveyance direction of the film 61 also corresponds to the sub-scanning direction. The carriage for ink in the present example is the carriage 10A, and is equipped with the first discharger that discharges the color ink and the second discharger that discharges the white ink. The carriage for treatment liquid in the present example is the carriage 10B, and is equipped with the third discharger that discharges the treatment liquid.

In the example illustrated in FIG. 21A, the carriage 10A is allowed to scan while the film 61 is conveyed in the forward path, and the color ink is discharged to the film 61. In a case where the film 61 reaches a discharge position of the treatment liquid during an operation of discharging the color ink, not only the carriage 10A but also the carriage 10B are allowed to scan. That is, the carriage 10A and the carriage 10B are allowed to scan in parallel. The control unit of the present example allows the carriage 10A and the carriage 10B to scan in the forward path of the film 61 to discharge the color ink and the treatment liquid in parallel. As a result, the treatment liquid can be efficiently discharged.

In the example illustrated in FIG. 21B, the carriage 10B is allowed to scan while the film 61 is conveyed in the backward path, and the treatment liquid is discharged to the film 61. In a case where the film 61 reaches a discharge position of the white ink during an operation of discharging the treatment liquid, not only the carriage 10B but also the carriage 10A are allowed to scan. That is, the carriage 10A and the carriage 10B are allowed to scan in parallel. The control unit of the present example allows the carriage 10A and the carriage 10B to scan in the backward path of the film 61 to discharge the white ink and the treatment liquid in parallel. As a result, the treatment liquid can be efficiently discharged.

A liquid discharge apparatus includes: a first head to discharge a color ink to a base material to transfer an image to a medium according to image data; a second head to discharge a white ink undercoating the color ink; a third head to discharge a treatment liquid containing an aggregating agent to the base material; and a control unit configured to: control the first head, the second head, and the third head to discharge the color ink, the white ink, and the treatment liquid, respectively; calculate a total adhesion amount of the color ink and the white ink discharged to each of regions of the image on the base material based on the image data; determine whether the total adhesion amount exceeds a predetermined threshold for each of the regions to determine a spot region; and control the third head to discharge the treatment liquid to the spot region.

The control unit is further configured to control the first head, the second head, and the third head to discharge the color ink, the treatment liquid, and the white ink in this order, to the spot region on the base material. The control unit is further configured to control the second head to discharge the white ink with an adhesion amount that prevents an effect of a color of the medium. The control unit is further configured to: control the first head to discharge the color ink with a first adhesion amount changed stepwise for each of the regions onto the base material; and control the second head to discharge the white ink with a second adhesion amount constant for each of the regions onto the base material, after discharging the color ink onto the base material, to print a first test chart.

The control unit is further configured to: control the first head to discharge the color ink with a first adhesion amount changed constant for each of the regions onto the base material; control the second head to discharge the white ink with a second adhesion amount constant for each of the regions onto the base material, after discharging the color ink onto the base material; and control the third head to discharge the treatment liquid with a third adhesion amount changed stepwise for each of the regions onto the base material, after discharging the color ink and before discharging the white ink onto the base material, to print a second test chart.

The control unit is further configured to control the third head to discharge the treatment liquid to the spot region for an adhesion amount that is 1/1000 to 1/10 of the total adhesion amount. The control unit is further configured to: set a size of a droplet of the treatment liquid to 12 pL or smaller; divide the spot region into pixels; randomly select landing pixels to which the third head discharges the droplet of the treatment liquid from the pixels to disperse the landing pixels across the regions of the image; and control the third head to discharge the treatment liquid to the landing pixels.

The liquid discharge apparatus includes a carriage mounting the third head, and the control unit is further configured to: control the third head to discharge the treatment liquid while scanning the carriage; control the carriage to scan the spot region; and control the carriage not to scan the regions other than the spot region.

The liquid discharge apparatus includes: a first carriage mounting the first head and the second head and scanning in a main scanning direction; a second carriage mounting the third head and scanning in the main scanning direction; and a conveyor configured to convey the base material in a sub-scanning direction orthogonal to the main scanning direction. The control unit is further configured to control the first carriage and the second carriage to scan in the main scanning direction and control the first head and the third head to discharge the color ink and the treatment liquid parallelly without discharging the white ink.

The liquid discharge apparatus includes: a first carriage mounting the first head and the second head and scanning in a main scanning direction; a second carriage mounting the third head and scanning in the main scanning direction; and a conveyor configured to convey the base material in a sub-scanning direction orthogonal to the main scanning direction, and the control unit is further configured to control the first carriage and the second carriage to scan in the main scanning direction and control the second head and the third head to discharge the white ink and the treatment liquid parallelly without discharging the color ink.

A liquid discharge method includes: discharging a color ink to a base material to transfer an image to a medium according to image data; discharging a white ink undercoating the color ink; discharging a treatment liquid containing an aggregating agent to the base material; calculating a total adhesion amount of the color ink and the white ink discharged to each of regions of the image on the base material based on the image data; determining whether the total adhesion amount exceeds a predetermined threshold for each of the regions to determine a spot region; and discharging the treatment liquid to the spot region.

The present embodiment can provide a liquid discharge apparatus that reduces color mixing of a color ink and a white ink and prevents deterioration in image quality in DTF printing.

Aspects of the present embodiment are, for example, as follows.

### Aspect 1

According to Aspect 1, a liquid discharge apparatus includes a first discharger that discharges a color ink to a transferring base material that transfers an image to a printed material, a second discharger that discharges a white ink serving as an undercoat of the color ink when the image is transferred to the printed material to the transferring base material, a third discharger that discharges a treatment liquid containing an aggregating agent to the transferring base material, and a control unit that controls discharge of the color ink, the white ink, and the treatment liquid, and the control unit controls to calculate a total adhesion amount of the color ink and the white ink for each predetermined region based on image data, and to discharge the treatment liquid to a region in which the total adhesion amount of the color ink and the white ink exceeds a predetermined threshold.

### Aspect 2

According to Aspect 2, in the liquid discharge apparatus of Aspect 1, the control unit controls to discharge the color ink, the treatment liquid, and the white ink to the transferring base material in this order when discharging the treatment liquid to the region in which the total adhesion amount of the color ink and the white ink exceeds a predetermined threshold.

### Aspect 3

According to Aspect 3, in the liquid discharge apparatus of Aspect 1 or 2, an adhesion amount of the white ink is determined by a specifying method of the adhesion amount of the white ink described below, and the control unit controls to discharge the white ink with the adhesion amount determined by the specifying method of the adhesion amount of the white ink described below.

### Method for Specifying Adhesion Amount of White Ink

The white ink is discharged to the transferring base material with any adhesion amount to form an image for specifying the adhesion amount, the image for determining the adhesion amount is transferred to the printed material, and an adhesion amount that is not affected by a color of the printed material is specified by any determination method.

### Aspect 4

According to Aspect 4, in the liquid discharge apparatus of any one of Aspects 1 to 3, the predetermined threshold compared with the total adhesion amount of the color ink and the white ink is determined by a first specifying method described below based on a first test chart described below, and the control unit controls discharge of the treatment liquid using the predetermined threshold determined by the specifying method described below.

### First Test Chart

An adhesion amount of the white ink is set to be constant, an adhesion amount of the color ink is changed stepwise, and the color ink and the white ink are discharged in this order to the transferring base material to prepare a plurality of test patches, which is taken as a first test chart.

### First Specifying Method

In the first test chart, it is determined whether mixture of the color ink and the white ink occurs by any determination method, a boundary between the test patch in which the mixture occurs and the test patch in which the mixture does not occur is obtained, and the total adhesion amount at the boundary is set as the predetermined threshold.

### Aspect 5

According to Aspect 5, in the liquid discharge apparatus of any one of Aspects 1 to 3, the control unit controls discharge of the treatment liquid based on an adhesion amount of the treatment liquid determined by a second specifying method described below using a second test chart described below.

### Second Test Chart

An adhesion amount of the color ink and an adhesion amount of the white ink are set to be constant, the adhesion amount of the treatment liquid is changed stepwise, and the color ink, the treatment liquid, and the white ink are discharged in this order to the transferring base material to prepare a plurality of test patches, which is taken as a second test chart.

### Second Specifying Method

In the second test chart, it is determined whether mixture of the color ink and the white ink occurs by any determination method, a boundary between the test patch in which the mixture occurs and the test patch in which the mixture does not occur is obtained, and the adhesion amount of the treatment liquid at the boundary is set as the adhesion amount of the treatment liquid at the time of image formation.

### Aspect 6

According to Aspect 6, in the liquid discharge apparatus of any one of Aspects 1 to 5, the control unit controls discharge of the treatment liquid so that an adhesion amount of the treatment liquid is 1/1000 to 1/10 with respect to a sum of an adhesion amount of the color ink and an adhesion amount of the white ink in a region in which the treatment liquid is discharged.

### Aspect 7

According to Aspect 7, in the liquid discharge apparatus of any one of Aspects 1 to 6, the control unit sets a size of a droplet of the treatment liquid to 12 pL or smaller, divides a region to which the treatment liquid is discharged by determination of a threshold into pixels that are units to which the droplet of the treatment liquid is landed, randomly selects the pixels so that the pixels to which the droplet of the treatment liquid is landed do not overlap, and discharges the treatment liquid to the selected pixels.

### Aspect 8

According to Aspect 8, the liquid discharge apparatus of any one of Aspects 1 to 7 further includes a carriage for treatment liquid equipped with the third discharger, the carriage for treatment liquid discharges the treatment liquid while scanning, and the control unit allows the carriage for treatment liquid to scan a portion where there is a region in which the treatment liquid is discharged, and does not allow the carriage for treatment liquid to scan a portion where there is no region in which the treatment liquid is discharged.

### Aspect 9

According to Aspect 9, the liquid discharge apparatus of any one of Aspects 1 to 8 includes a carriage for ink equipped with the first discharger and the second discharger, a carriage for treatment liquid equipped with the third discharger, and a conveyor that conveys the transferring base material, wherein the conveyor is conveyable the transferring base material in a forward path and a backward path, the carriage for ink and the carriage for treatment liquid perform reciprocating scanning in a direction perpendicular to a conveyance direction of the transferring base material, and the control unit allows the carriage for ink and the carriage for treatment liquid to scan in the forward path or the backward path of the transferring base material to discharge the color ink and discharge the treatment liquid in parallel, or discharge the white ink and discharge the treatment liquid in parallel.

### Aspect 10

According to Aspect 10, a liquid discharge method includes a first discharge step of discharging a color ink to a transferring base material that transfers an image to a printed material, a second discharge step of discharging a white ink serving as an undercoat of the color ink when the image is transferred to the printed material to the transferring base material, a third discharge step of discharging a treatment liquid containing an aggregating agent to the transferring base material, and a control step of controlling discharge of the color ink, the white ink, and the treatment liquid, and the control step controls to calculate a total adhesion amount of the color ink and the white ink for each predetermined region based on image data, and to discharge the treatment liquid to a region in which the total adhesion amount of the color ink and the white ink exceeds a predetermined threshold.

According to the present embodiment, it is possible to provide a liquid discharge apparatus that reduces color mixing of a color ink and a white ink and prevents deterioration in image quality in DTF printing.

Any one of the above-described operations may be performed in various other ways, for example, in an order different from the one described above.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A liquid discharge apparatus comprising:
a first head to discharge a color ink to a base material to transfer an image to a medium according to image data;
a second head to discharge a white ink undercoating the color ink;
a third head to discharge a treatment liquid containing an aggregating agent to the base material; and
a control unit configured to:
control the first head, the second head, and the third head to discharge the color ink, the white ink, and the treatment liquid, respectively;
calculate a total adhesion amount of the color ink and the white ink discharged to each of regions of the image on the base material based on the image data;
determine whether the total adhesion amount exceeds a predetermined threshold for each of the regions to determine a spot region; and
control the third head to discharge the treatment liquid to the spot region.

2. The liquid discharge apparatus according to claim 1,
wherein the control unit is further configured to control the first head, the second head, and the third head to discharge the color ink, the treatment liquid, and the white ink in this order, to the spot region on the base material.

3. The liquid discharge apparatus according to claim 1,
wherein the control unit is further configured to control the second head to discharge the white ink with an adhesion amount that prevents an effect of a color of the medium.

4. The liquid discharge apparatus according to claim 1,
wherein the control unit is further configured to:
control the first head to discharge the color ink with a first adhesion amount changed stepwise for each of the regions onto the base material; and
control the second head to discharge the white ink with a second adhesion amount constant for each of the regions onto the base material, after discharging the color ink onto the base material,
to print a first test chart.

5. The liquid discharge apparatus according to claim 1,
wherein the control unit is further configured to:
control the first head to discharge the color ink with a first adhesion amount changed constant for each of the regions onto the base material;
control the second head to discharge the white ink with a second adhesion amount constant for each of the regions onto the base material, after discharging the color ink onto the base material; and
control the third head to discharge the treatment liquid with a third adhesion amount changed stepwise for each of the regions onto the base material, after discharging the color ink and before discharging the white ink onto the base material,
to print a second test chart.

6. The liquid discharge apparatus according to claim 1,
wherein the control unit is further configured to control the third head to discharge the treatment liquid to the spot region for an adhesion amount that is 1/1000 to 1/10 of the total adhesion amount.

7. The liquid discharge apparatus according to claim 1,
wherein the control unit is further configured to:
set a size of a droplet of the treatment liquid to 12 pL or smaller;
divide the spot region into pixels;
randomly select landing pixels to which the third head discharges the droplet of the treatment liquid from the pixels to disperse the landing pixels across the regions of the image; and
control the third head to discharge the treatment liquid to the landing pixels.

8. The liquid discharge apparatus according to claim 1, comprising a carriage mounting the third head,
wherein the control unit is further configured to:
control the third head to discharge the treatment liquid while scanning the carriage;
control the carriage to scan the spot region; and
control the carriage not to scan the regions other than the spot region.

9. The liquid discharge apparatus according to claim 1, comprising:
a first carriage mounting the first head and the second head and scanning in a main scanning direction;
a second carriage mounting the third head and scanning in the main scanning direction; and
a conveyor configured to convey the base material in a sub-scanning direction orthogonal to the main scanning direction,
wherein the control unit is further configured to control the first carriage and the second carriage to scan in the main scanning direction and control the first head and the third head to discharge the color ink and the treatment liquid parallelly without discharging the white ink.

10. The liquid discharge apparatus according to claim 1, comprising:
a first carriage mounting the first head and the second head and scanning in a main scanning direction;
a second carriage mounting the third head and scanning in the main scanning direction; and
a conveyor configured to convey the base material in a sub-scanning direction orthogonal to the main scanning direction,
wherein the control unit is further configured to control the first carriage and the second carriage to scan in the main scanning direction and control the second head and the third head to discharge the white ink and the treatment liquid parallelly without discharging the color ink.

11. A liquid discharge method comprising:
discharging a color ink to a base material to transfer an image to a medium according to image data;
discharging a white ink undercoating the color ink;
discharging a treatment liquid containing an aggregating agent to the base material;
calculating a total adhesion amount of the color ink and the white ink discharged to each of regions of the image on the base material based on the image data;
determining whether the total adhesion amount exceeds a predetermined threshold for each of the regions to determine a spot region; and
discharging the treatment liquid to the spot region.
